(19) United States
(12) Patent Application Publication
(10) Pub. No.: US 2010/0223760 A1
(43) Pub. Date: Sep. 9, 2010

(54) HANDLE VIBRATION DAMPING DEVICE

(76) Inventors: Thilo Henke, Stuttgart (DE); Holger Frank, Pfulingen (DE)

Correspondence Address: MICHAEL J. STRIKER, 103 EAST NECK ROAD, HUNTINGTON, NY, 11743, US

(21) Appl. No.: 12/160,360

(22) PCT Filed: Sep. 20, 2007
(86) PCT No.: PCT/EP07/59943

§ 371 Date: Jul. 9, 2008

(30) Foreign Application Priority Data
Nov. 16, 2006 (DE) 10 2006 054 189.8

(51) Int. Cl. B25G 1/01; F16F 15/00; B25D 17/04; B25D 17/24; B25F 5/02

(52) U.S. Cl. 16/431

(57) ABSTRACT

The invention is based on a handle vibration damping device, in particular for hand-held machine tools (12), comprising a handle (14) and a damping unit (16), which has at least one damping means (18). It is proposed that the damping means (18) is formed by a rheological damping means (18).

### PRIOR ART

The invention is based on a handle vibration damping device as defined by the preamble to claim 1. Moreover, the invention is based on a method as defined by the preamble to claim 11.

A handle vibration damping device for a handheld power tool that has a damping unit with at least one damping means is already known.

### ADVANTAGES OF THE INVENTION

The invention is based on a handle vibration damping device, in particular for handheld power tools with a handle, having a damping unit that has at least one damping means.

It is proposed that the damping means be formed by a rheological damping means, as a result of which a damping property of the damping means can be varied especially quickly and effectively in that an immediate change in an internal parameter, in particular of a damping means-specific parameter, such as a flow property or viscosity, can be achieved by changing an external parameter, such as an action of a force. In addition, the damping property of the rheological damping means can be parametrized within a performance graph and is thus variable in its damping property with a wide range. In this connection, the term “rheological damping means” should be understood in particular to mean a damping means in which, by means of an action of external forces, for instance, such as a shear force in particular, or an application of an electrical field and/or a magnetic field, and so forth, an immediate change in an internal structure of the damping means or a change in an interaction of damping means particles with one another can be attained. The change in the internal structure of the damping means preferably causes a rheological change, such as a change in viscosity in particular, and affects a damping force. The action of the external forces can be controlled manually by a user or especially advantageously can be adjusted at least partly automatically via a control or regulating unit. The rheological damping means is preferably formed by a damping fluid, and especially preferably by a suspension, in particular of an oil with polyurethane molecules contained in it. In principle, however, still other fluids and/or materials, such as a gel and so forth, that appear useful to one skilled in the art are conceivable at any time in an alternative embodiment of the invention. Expediently, the handle vibration damping device is located inside the handheld power tool, in order to protect a handle and in particular a user from unwanted vibration in operation of the handheld power tool.

It is furthermore proposed that the rheological damping means is formed by an electrorheological damping means; as a result, in a structurally simple way, by applying an electrical voltage or an electrical field, a flow property, such as viscosity in particular, of the electrorheological damping means can be varied or adjusted.

It is also proposed that the handle vibration damping device have a computation unit, which is intended for at least partially automatic adaptation of the rheological damping means to at least one usage situation. As a result, especially advantageously, great user comfort for a person operating a handheld power tool with a handle vibration damping device and in particular high-speed control and/or regulation of the damping property, preferably within the range of milliseconds, to the usage situation at the moment can be achieved. The term “computation unit” is intended to be understood as a monitoring unit, control unit, and/or regulating unit; a computation unit may be formed either by a processor alone or in particular by a processor along with further electronic components, such as memory means.

A structurally simple and in particular fast adaptation to a usage situation can be attained if the computation unit varies an electrical voltage, applied to the rheological damping means, as a function of at least one parameter.

In a further feature of the invention, it is proposed that the computation unit have a sensor unit, which is intended for detecting at least one motion parameter; as a result, advantageous sensing of a vibrational motion, particularly of a handheld power tool, and moreover advantageous adaptation inside the handle vibration damping device can be achieved. The term “motion parameter” should be understood in particular to mean a parameter for detecting a motion, in particular a vibrational motion, by means of a change in travel distance, a change in speed, and/or a change in acceleration.

It is also proposed that the computation unit apply a constant electrical voltage within at least one partial region of the rheological damping means, as a result of which advantageous control of vibration damping, and in particular vibration damping adapted to a material of a workpiece to be machined, can be attained along a characteristic damping curve. A value of the constant electrical voltage and of an electrical field thus generated can be adjusted manually by a user of the handheld power tool or, especially advantageously, at least partly automatically by the computation unit. Preferably, the electrical field is generated by means of a capacitor, in particular by means of a cylindrical capacitor, and the electrical field is limited essentially to the partial region between capacitor faces.

If a length of the partial region is variably adjustable, then a damping behavior of the rheological damping means can be varied by means of the variable length, and a damping property can advantageously be adapted to a vibration behavior of the handheld power tool.

It is furthermore proposed that the length of the partial region be variable, by means of a motion of at least one electrical discharge face, for applying the electrical voltage. The partial region of the rheological damping means with the applied electrical field can be increased or decreased in size, and a damping behavior of the rheological damping means can advantageously be adapted to a vibration situation at that moment, in particular in the case of tubes or cylinders of a capacitor that is displaceable inside one another, as is the case for instance with a cylindrical capacitor.

In an advantageous refinement of the invention, it is proposed that the damping unit have at least one spring means, which is connected in a parallel arrangement with the rheological damping means. Advantageous and especially effect vibration decoupling of a handle from a handheld power tool can thus be achieved by means of damping and simultaneous cushioning.

It is also proposed that the damping unit have at least one spring means which is connected in a serial arrangement with the rheological damping means, as a result of which advantageous successively connected filtration of vibration can be achieved for the vibration damping. Moreover, in vibration with major pulse transformation, especially effective vibration damping can be achieved by means of the serial arrangement.

In a further feature of the invention, a method with a handle vibration damping device, in particular for handheld power tools with a handle, is proposed in which a damping property of a rheological damping means is varied, as a result of which a damping property of the damping means can be varied especially quickly and effectively in that an immediate change in an internal parameter, in particular of a damping means-specific parameter, such as a flow property or viscosity, can be achieved by changing an external parameter, such as an action of a force. In addition, the damping property of the rheological damping means can be parametrized within a performance graph and is thus variable in its damping property with a wide range. The term “computation unit” is intended to be understood as a monitoring unit, control unit, and/or regulating unit; a computation unit may be formed either by a processor alone or in particular by a processor along with further electronic components, such as memory means.

It is furthermore proposed that an electrical voltage in at least one partial region of the rheological damping means be varied as a function of a motion parameter, as a result of which especially fast adaptation to a usage situation can be achieved. Preferably, the electrical voltage is adjusted by a computation unit, so that in addition great user comfort for a person operating a handheld power tool with a handle vibration damping device can be attained.

Advantageous control of vibration damping, in particular vibration damping adapted to a material of a workpiece to be machined, along a characteristic damping curve can be attained if a constant electrical voltage is applied in at least one partial region of the rheological damping means. The constant electrical voltage and an electrical field generated with it can be adjusted manually by a user of the handheld power tool or especially advantageously at partly automatically by means of the computation unit. The electrical field is preferably generated by means of a capacitor, in particular by means of a cylindrical capacitor, and the electrical field is essentially limited to the partial region between capacitor faces.

If the partial region having the constant electrical voltage is varied in its length, then a damping behavior of the rheological damping means can be varied, and a damping property can advantageously be adjusted as a function of a vibration behavior of the handheld power tool. Preferably, the length of the partial region is varied, by means of a motion of at least one electrical discharge face, for applying the electrical voltage for instance as in tubes or cylinders of a capacitor, in particular a cylindrical capacitor, that are displaceable inside one another, and thus the partial region of the rheological damping means with the applied electrical field can be increased or decreased in size, or a damping behavior of the rheological damping means can be varied.

In an advantageous refinement of the invention, it is proposed that a vibration damping is adjusted on the basis of a material recognition, as a result of which a vibration damping in the rheological damping means can be attained that is adapted to a material of a workpiece to be machined. The material recognition of the handle vibration damping device can be adjustable manually by a user and/or can be effected especially advantageously by means of an at least partly automatic material recognition at the beginning of a work operation. Preferably, during the operation of the handheld power tool, the handle vibration damping device or the computation unit recognizes the material of the workpiece to be machined from a vibration pattern and automatically decides on the vibration damping of the handle of the handheld power tool by way of an advantageous damping strategy.

### DRAWINGS

Further advantages will become apparent from the ensuing description of the drawings. In the drawings, exemplary embodiments of the invention are shown. The drawings, description and claims include numerous characteristics in combination. One skilled in the art will in a practical way also consider the characteristics individually and put them together to make further appropriate combinations.

Shown are:

FIG. 1, a handheld power tool with a handle vibration damping device of the invention, in a schematic side view;

FIG. 2, a rheological damping means of the handle vibration damping device in a parallel arrangement with a spring;

FIG. 3, the rheological damping means in an alternative parallel arrangement to FIG. 2, with a spring;

FIG. 4, the rheological damping means in a serial arrangement with a spring;

FIG. 5, the electrorheological damping means of the handle vibration damping device;

FIG. 6a, the handle vibration damping device with a travel sensor;

FIG. 6b, a characteristic voltage curve of the travel sensor as a function of a time;

FIG. 7a, the handle vibration damping device with an acceleration sensor in the handle;

FIG. 7b, the handle vibration damping device with the acceleration sensor in the handheld power tool;

FIG. 7c, a characteristic voltage curve of the acceleration sensor as a function of a time;

FIG. 8a, an alternative electrorheological damping means to FIG. 5, in a first damping position;

FIG. 8b, the electrorheological damping means of FIG. 8a in a second damping position;

FIG. 9a, a view of an overlapping length of the electrorheological damping means of FIG. 8 as a function of a time; and

FIG. 9b, a view of a resultant contrary force of the electrorheological damping means of FIG. 8 as a function of the time.

### DESCRIPTION OF THE EXEMPLARY EMBODIMENTS

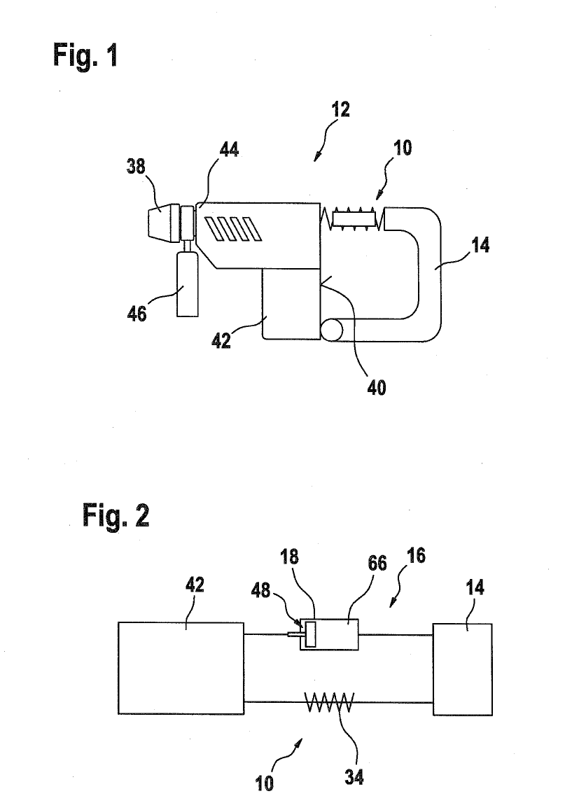

In FIG. 1, a handheld power tool 12 is shown, with a handle vibration damping device 10 according to the invention and with a rotary and/or percussion drive, not shown in further detail, for a tool receptacle 38 or a tool located in the tool receptacle 38. The handle vibration damping device 10 is part of a handle 14, formed by a main handle, and together with it is located on a side 40, facing away from the tool receptacle 38, of a base body 42 of the handheld power tool 12. By means of the main handle, in operation of the handheld power tool 12, a force of the user is transmitted to the base body 42 of the handheld power tool. On a side 44 facing toward the tool receptacle 38 of the base body 42 of the handheld power tool, the base body has an additional handle 46, and the additional handle 46, in operation of the handheld power tool 12, is intended for guidance of the handheld power tool 12 by a user. In principle, it is also conceivable to locate the handle vibration damping device 10 on further handheld power tools 12 that appear appropriate to one skilled in the art.

For damping vibration that occurs in operation of the handheld power tool 12, the handle vibration damping device 10 has a damping unit 16. In the schematically shown FIGS. 2 through 4, the damping unit 16 has an electrorheological damping means 18, with an electrorheological damping fluid 66, a damping means embodied as a spring means 34, 36, and an electrical voltage unit 48. The electrorheological damping fluid 66 is formed by an oil containing polyurethane molecules. In principle, however, still other damping means 18 appearing appropriate to one skilled in the art are conceivable in an alternative embodiment of the invention, such as a magnetorheological damping means, and so forth.

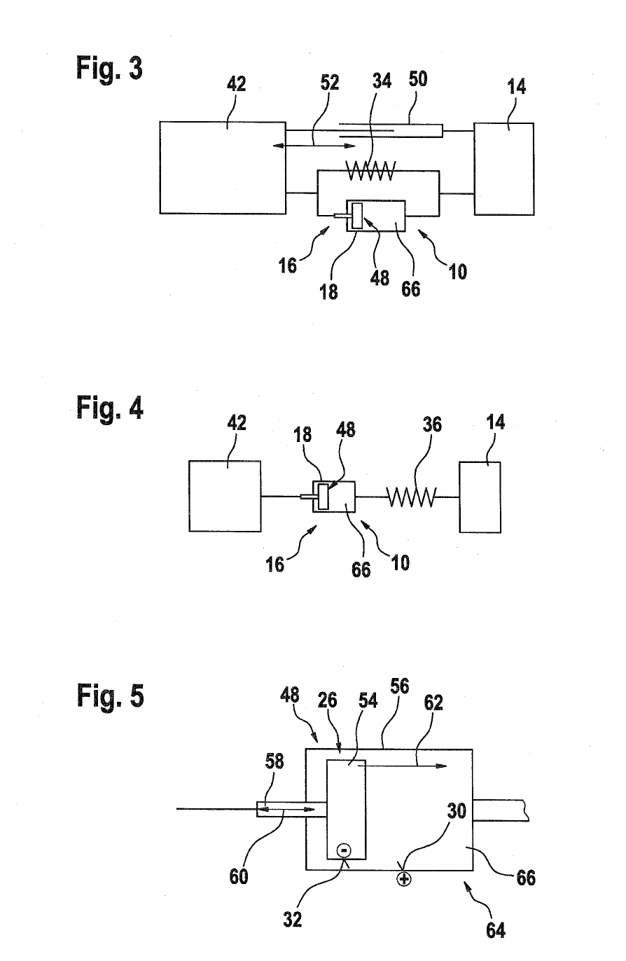

The electrorheological damping means 18 in the spring means 34, in a first embodiment of the handle vibration damping device 10 according to the invention, are located parallel to one another (FIGS. 2 and 3). By means of the parallel arrangement, vibration of the handheld power tool 12 in a vibration damping operation is simultaneously damped and cushioned in the handle vibration damping device 10, and thus maximum vibration decoupling of the handle 14 from the base body 42 of the handheld power tool is achieved. In an arrangement of the invention in FIG. 3, which is an alternative to FIG. 2, in addition to the parallel arrangement of the electrorheological damping means 18 and spring means 34, the handle 14 is also connected to the base body 42 of the handheld power tool via an axially movable guide 50 of the handle 14. The guide 50 is connected parallel to the parallel arrangement of the electrorheological damping means 18 and the spring means 34 and thus compensates for motions of the base body 42 of the handheld power tool relative to the handle that extend axially along a machining axis 52. In FIG. 4, an arrangement of the electrorheological damping means 18 together with the spring means 36 that is an alternative to FIGS. 2 and 3 is also shown, in which the electrorheological damping means 18 is connected in series with the spring means.

In FIG. 5, an enlarged detail of the electrorheological damping means 18, which is based on a mode of operation of a hydraulic damper, is shown. For that purpose, the electrorheological damping means 18 includes a piston 54, coupled to the base body 42 of the handheld power tool, and a cylinder 56, coupled to the handle 14, and the piston and cylinder are located movably relative to one another. The piston 54 is moved inside the cylinder 56 by means of a piston guide 58 along an axis 60, which is parallel to a main lengthwise direction 62 of the cylinder 56. Moreover, the cylinder 56 forms a positive discharge face 30 and the piston 54 forms a negative discharge face 32 of the electrical voltage unit 48 that is embodied by a cylindrical capacitor 64. By means of the electrical voltage unit 48, in operation of the handle vibration damping device 10 or of the handheld power tool 12, an electrical voltage or an electrical field is applied inside a partial region 26 of the electrorheological damping means 66. The piston 54 has a cylindrical shape, so that the partial region 26 is limited to a gap between a cylindrical jacket face of the piston 54 and a cylinder jacket face, diametrically opposite it radially outward, of the cylinder 56. By means of the piston guide 58, which assures a stable alignment and motion of the piston 54 along the axis 60 inside the cylinder 56, a spacing between the piston 54 and the cylinder 56 is kept virtually constant, and unwanted contact of the piston 54 with the cylinder 56 and thus an unwanted discharge of the cylindrical capacitor 64 are avoided.

By means of the applied electrical voltage or the applied electrical field, an alignment or concatenation of the polyurethane molecules inside the partial region 26 is varied; this has an effect on a rheology or viscosity of the electrorheological damping fluid 66. With the applied electrical voltage, the alignment of the molecules increases, and thus the viscosity or a hydraulic resistance of the electrorheological damping fluid 66 also increases in the partial region 26. Along with this, a damping property, in the form of a damping force of the electrorheological damping fluid 66, increases as well.

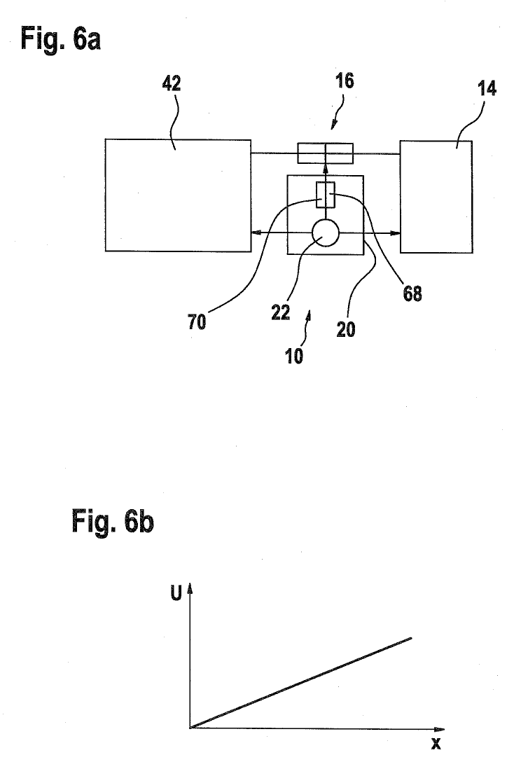

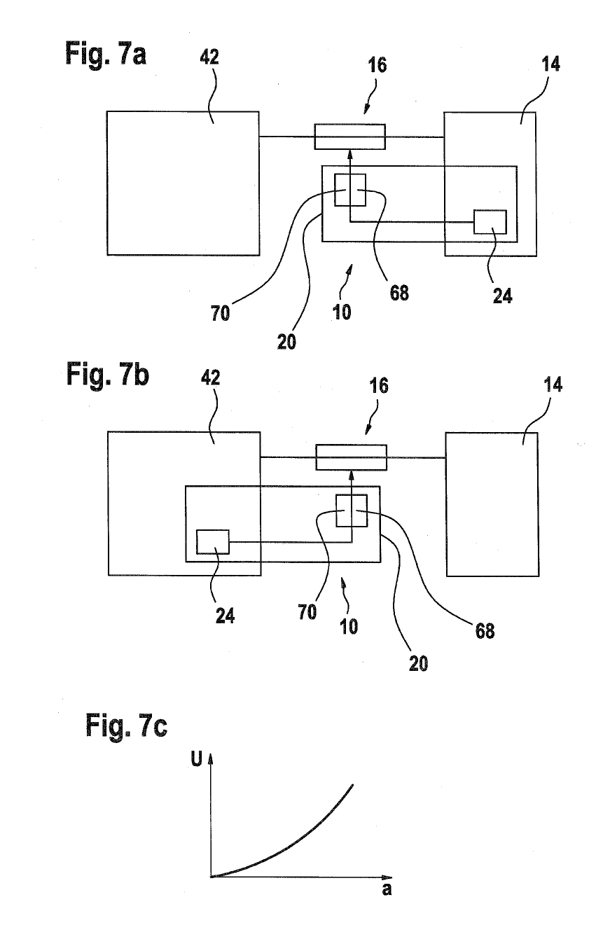

The handle vibration damping device 10 furthermore includes a computation unit 20, which is intended at least partially for automatic adaptation to a usage situation of the handheld power tool 12 (FIGS. 6a, 7a and 7b). By means of the computation unit 20, the applied electrical voltage or the electrical field is varied quickly and reversibly in operation of the handheld power tool 12, as a function of a parameter. To that end, the computation unit 20 includes a sensor unit 22, 24 and a control and regulating unit 68. The sensor unit 22, 24 detects a motion parameter inside the handle vibration damping device 10, and on the basis of this parameter, the requisite damping property, in the form of an electrical voltage, is adjusted in, the electrical voltage unit 48 by way of the control and regulating unit 68. The motion parameter is determined as a function of a travel parameter, speed parameter or acceleration parameter of a relative vibrational motion of the base body 42 of the handheld power tool relative to the handle 14.

For sensing a relative travel parameter, the sensor unit 22 in FIG. 6a is formed by a travel sensor, which, on the basis of a varying spacing, ascertains a relative motion between the base body 42 of the handheld power tool and the handle 14. From the motion parameter sensed, the voltage required for damping the handle 14 is adjusted in the electrical voltage unit 48 by means of the computation unit 20 by way of regulation and/or control. To that end, the computation unit 20 additionally has a performance graph storage unit 70, in which the parameters sensed by the sensor unit 22 is compared with characteristic curves, stored in memory in the performance graph storage unit 70, or with a performance graph of the electrorheological damping fluid 66 that is stored in memory. From the stored data, the electrical voltage at the electrorheological damping fluid 66 that is to be adjusted is ascertained especially quickly, and the damping property or damping force of the electrorheological damping fluid 66 is adapted in the best possible way to an amplitude and/or frequency of the vibration generated in the base body 42 of the handheld power tool.

In FIG. 6b, a course of an adjustable electrical voltage U of the sensed motion parameter is represented in the form of a travel parameter x; the voltage U is proportional to the sensed travel parameter x. The travel parameter x corresponds to an amplitude of a vibration of the base body 42 of the handheld power tool, so that upon major vibration of great amplitude, which corresponds to a large travel parameter x, a high voltage U is applied in the partial region 26 of the electrorheological damping means 18 by the control and regulating unit 68, and thus a high damping force adapted to the vibration is generated in the handle vibration damping device 10 as a function of the travel parameter. Since the travel parameter x of the vibrational motion varies as a function of time, the voltage U also varies as a function of time within milliseconds, by means of the rapid adaptation of the electrorheological damping means 18 by the computation unit, and thus the damping force is adapted to a vibrational motion at that time.

In an embodiment of the sensor unit 22 as a travel sensor that is an alternative to FIG. 6a, the sensor unit 24 is shown in FIGS. 7a, 7b, formed by an acceleration sensor. The acceleration sensor is located in the handle 14 of the handheld power tool 12 (FIG. 7a) or as an alternative to that in the base body 42 of the handheld power tool (FIG. 7b). An acceleration during a vibration of the base body 42 of the handheld power tool, or during a relative motion between the handle 14 and the base body 42 of the handheld power tool is sensed, and in an analogous procedure to the embodiment of the sensor unit 22 with a travel sensor (FIG. 6a), an electrical voltage to be applied in the electrorheological damping means 18 is ascertained via the control and regulating unit 68, together with the performance graph storage unit 70.

In FIG. 7c, a course of an adjustable electrical voltage U of the sensed motion parameter is shown in the form of an acceleration parameter a; the voltage U increases with the sensed acceleration parameter a. Upon major accelerations, such as at high frequencies of the vibration generated by the base body 42 of the handheld power tool, a correspondingly high voltage U is applied by the control and regulating unit 68 within the partial region 26 of the electrorheological damping means 18 as a function of the acceleration parameter, and a high damping force adapted to the vibration is generated in the handle vibration damping device 10. The acceleration parameter a varies with the vibrational motion as a function of time, so that in an analogous procedure to FIG. 6b, or to the adjustment of the damping force with a travel sensor, the voltage U varies as a function of time, and thus the damping force is adapted to an instantaneous vibrational motion.

An adaptation of the electrical voltage to the usage situation at the moment is effected by means of the control and regulating unit 68. For a user of the handheld power tool 12, the possibility thus exists of adjusting a damping behavior of the handle vibration damping device 10 by way of a closed- or open-loop control circuit of the control and regulating unit 68. If the damping behavior is adjusted via the open-loop control circuit, the user can choose between manual control, which is adjustable by the user, or automatic control by means of the control and regulating unit 68. In manual control, the user specifies a damping behavior to be controlled and preset in the control and regulating unit 68 or the performance graph storage unit 70, to the control and regulating unit 68, and these behavior is determined by the user for instance on the basis of a material of a workpiece to be machined. By means of the preset damping behavior, the vibration of the handheld power tool 12 is approximately damped via the handle vibration damping device 10.

In the automatic control of the damping behavior, the operation of the handheld power tool 12 initially takes place without damping, so that by means of the computation unit 20, on the basis of a vibration pattern, a conclusion is drawn as to a material property or a material of the workpiece to be machined. By means of the material property or the material itself of the workpiece to be machined, a damping strategy is developed by the computation unit on the basis of characteristic curves stored in memory in the performance graph storage unit 70. The damping behavior of the damping strategy is adapted to the vibration pattern of the material and/or workpiece to be machined. By means of the control by the control and regulating unit 68, fast control of the damping behavior in the electrorheological damping means 18 is attained on the basis of the damping strategy developed.

If the vibration damping is effected via the closed-loop control circuit, then a damping force that is dependent on the amplitude and/or frequency of the vibration generated is thus adjusted in the electrorheological damping means. By means of the adaptive regulation, the damping behavior is adapted constantly, by means of the sensor unit 22, 24 and the control and regulating unit 68, to a current usage situation or vibration situation, and as a result, efficient and effective vibration damping is attained. In a further regulation variant, it is possible for a user to utilize the regulation only at certain time intervals for monitoring the manual or automatic control.

In a further embodiment of the handle vibration damping device 10 of the invention, a partial region 26 of an electrorheological damping fluid 66 can be varied in its length L by applying an electrical voltage or an electrical field. A constant electrical voltage is applied within the partial region 26 by means of the computation unit 20, so that a different damping behavior, adapted to a usage situation of the handheld power tool 12, is established via the variable length L of the partial region 26. The variable length L of the partial region 26 results from a relative motion along an axis 60 of both discharge faces 30, 32 of a cylindrical capacitor 64 relative to one another, which is brought about by a vibrational motion of the base body 42 of the handheld power tool relative to the handle 14.

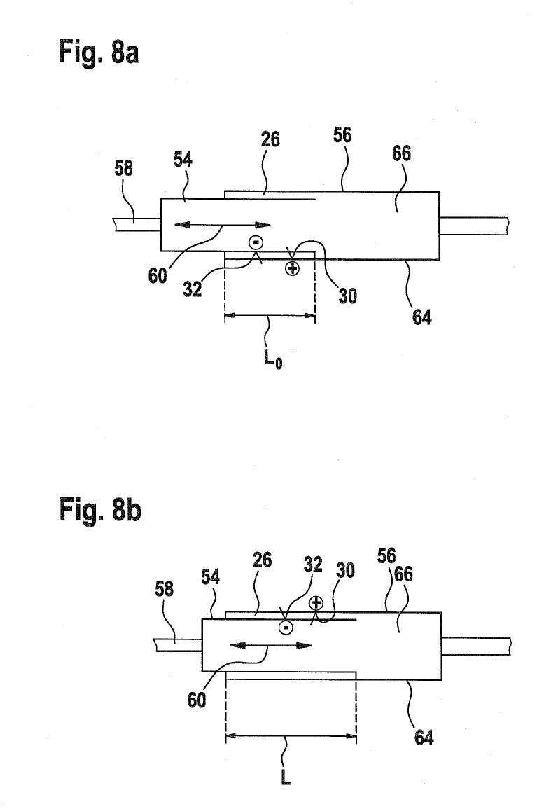

To achieve a variable length L of the partial region 26 upon a relative motion of the two discharge faces 30, 32 to one another, a negatively charged piston 54, coupled to the base body 42 of the handheld power tool, of the cylindrically embodied capacitor 64 is embodied cylindrically. The length L of the overlapping partial region 26 of the two discharge faces 30, 32 is varied by means of the vibration behavior of the handheld power tool 12, or the base body 42 of the handheld power tool, and thus the damping behavior of the damping unit, in that the cylindrical piston 54, as a function of an instantaneous vibration behavior of the base body 42 of the handheld power tool, extends variously far into a positively charged cylinder 56 that is coupled to the handle 14. If severe vibration with high amplitude occurs, the cylindrical piston 54 is pressed into the cylinder 56 of the cylindrical capacitor 64 by the vibration, and a length L of the overlapping partial region 26 of the two discharge faces 30, 32 increases (FIG. 8b).

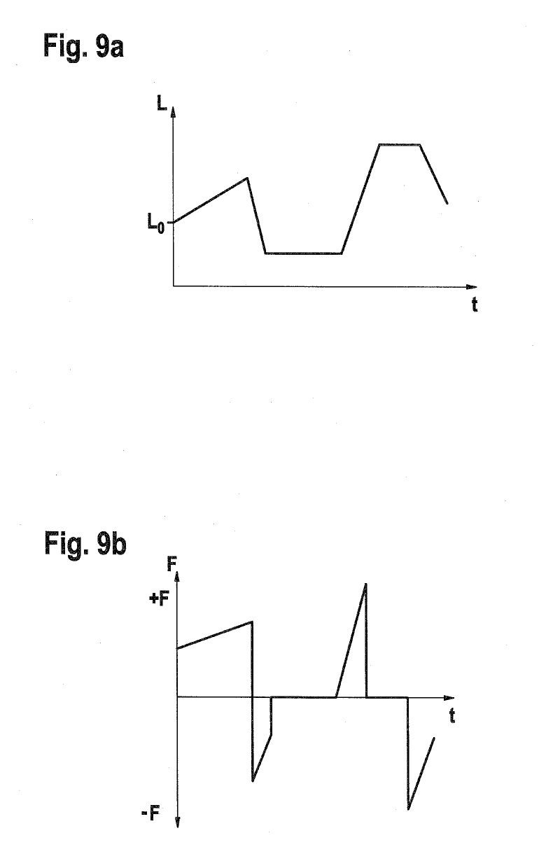

In FIG. 9a, a course of the overlapping length L of the two discharge faces 30, 32 is shown over a time t. Based on an overlapping length L₀ in a state of repose of the handle vibration damping device 10, the length L varies with the vibration behavior of the base body 42 of the handheld power tool relative to the handle 14 and correspondingly increases or decreases with the vibration behavior. Since with the overlapping length L, an effective area of the two discharge faces 30, 32 changes, a damping force F of the electrorheological damping means 18 (FIG. 9b) varies with the effective area of the length.

1. A handle vibration damping device, in particular for handheld power tools (12) with a handle (14), having a damping unit (16) which has at least one damping means (18), characterized in that the damping means (18) is formed by a rheological damping means (18).

2. The handle vibration damping device as defined by claim 1, characterized in that the rheological damping means (18) is formed by an electrorheological damping means (18).

3. The handle vibration damping device as defined by claim 1, characterized by a computation unit (20), which is intended for at least partially automatic adaptation of the rheological damping means (18) to at least one usage situation.

4. The handle vibration damping device as defined by claim 3, characterized in that the computation unit (20) varies an applied electrical voltage as a function of at least one parameter.

5. The handle vibration damping device as defined by claim 3, characterized in that the computation unit (20) has a sensor unit (22, 24), which is intended for detecting at least one motion parameter.

6. The handle vibration damping device as defined by claim 3, characterized in that the computation unit (20) applies a constant electrical voltage within at least a partial region (26) of the rheological damping means (18).

7. The handle vibration damping device as defined by claim 6, characterized in that a length (L) of the partial region (26) is variably adjustable.

8. The handle vibration damping device as defined by claim 6, characterized in that the length (L) of the partial region (26) is variable, by means of a motion of at least one electrical discharge face (30, 32), for applying the electrical voltage.

9. The handle vibration damping device as defined by claim 1, characterized in that the damping unit (16) has at least one spring means (34), which is connected in a parallel arrangement with the rheological damping means (18).

10. The handle vibration damping device as defined by claim 1, characterized in that the damping unit (16) has at least one spring means (36), which is connected in a serial arrangement with the rheological damping means (18).

11. A method having a handle vibration damping device, in particular for handheld power tools (12) with a handle (14), as defined by claim 1, characterized in that a damping property of a rheological damping means (18) is varied.

12. The method as defined by claim 11, characterized in that an electrical voltage in at least one partial region (26) of the rheological damping means (18) is varied as a function of a motion parameter.

13. The method as defined by claim 11, characterized in that a constant electrical voltage is applied in at least a partial region (26) of the rheological damping means (18).

14. The method as defined by claim 13, characterized in that the partial region (26) having the constant electrical voltage is varied in its length (L).

15. The method as defined by claim 11, characterized in that a vibration damping is adjusted on the basis of a material recognition.

16. The method as defined by at least claim 15, characterized in that the material recognition is effected automatically at the beginning of a work process.
